(19) United States
(12) Patent Application Publication
(10) Pub. No.: US 2017/0094622 A1
(43) Pub. Date: Mar. 30, 2017

(54) METHOD FOR PERFORMING SYNCHRONIZATION WITH BASE STATION IN WIRELESS COMMUNICATION SYSTEM, AND APPARATUS THEREFOR

(71) Applicant: LG Electronics Inc., Seoul (KR)

(72) Inventors: Genebeck Hahn, Seoul (KR); Jaehoon Chung, Seoul (KR); Eunjong Lee, Seoul (KR); Jinmin Kim, Seoul (KR); Kukheon Choi, Seoul (KR); Kwangseok Noh, Seoul (KR)

(21) Appl. No.: 15/315,882

(22) PCT Filed: Apr. 2, 2015
(86) PCT No.: PCT/KR2015/003304

§ 371 Date: Dec. 2, 2016

Related U.S. Application Data
(60) Provisional application No. 62/022,682, filed on Jul. 10, 2014.

(51) Int. Cl. H04W 56/00

(52) U.S. Cl. CPC H04W 56/001; H04W 56/0005

(57) ABSTRACT

Disclosed is a method for performing, by a wireless device, synchronization with a base station in a wireless communication system. A method for synchronizing a wireless device according to one embodiment of the present invention comprises the steps of: receiving a primary synchronization signal and an auxiliary synchronization signal through a first subframe from a first base station; and performing synchronization with the first base station using the primary synchronization signal and the auxiliary synchronization signal, wherein the synchronization with the first base station is performed depending on whether a moving cell synchronization signal exists on the first subframe.

### TECHNICAL FIELD

The present invention relates to a wireless communication system, and more particularly, to a method for a wireless device to perform synchronization with a base station by receiving a synchronization signal.

### BACKGROUND ART

As one example of a wireless communication system to be improved by having the present invention apply thereto, 3GPP LTE (3^{rd} generation partnership project long term evolution) (hereinafter abbreviated LTE) communication system is schematically described as follows.

FIG. 1 is a schematic diagram of E-UMTS network structure as an example of a wireless communication system.

E-UMTS (evolved universal mobile telecommunications system) is the system evolved from a conventional UMTS (universal mobile telecommunications system) and its basic standardization is progressing by 3GPP. Generally, E-UMTS can be called LTE (long term evolution) system. For the details of the technical specifications of UMTS and E-UMTS, Release 7 and Release 8 of ‘3rd Generation Partnership Project: Technical Specification Group Radio Access Network’ can be referred to.

Referring to FIG. 1, E-UMTS consists of a user equipment (UE) 120, base stations (eNode B: eNB) 110a and 110b and an access gateway (AG) provided to an end terminal of a network (E-UTRAN) to be connected to an external network. The base station is able to simultaneously transmit multi-data stream for a broadcast service, a multicast service and/or a unicast service.

At least one or more cells exist in one base station. The cell is set to one of bandwidths including 1.25 MHz, 2.5 MHz, 5 MHz, 10 MHz, 15 MHz, 20 MHz and the like and then provides an uplink or downlink transmission service to a plurality of user equipments. Different cells can be set to provide different bandwidths, respectively. A base station controls data transmissions and receptions for a plurality of user equipments. A base station sends downlink scheduling information on downlink (DL) data to inform a corresponding user equipment of time/frequency region for transmitting data to the corresponding user equipment, coding, data size, HARQ (hybrid automatic repeat and request) relevant information and the like. And, the base station sends uplink scheduling information on uplink (UL) data to a corresponding user equipment to inform the corresponding user equipment of time/frequency region available for the corresponding user equipment, coding, data size, HARQ relevant information and the like. An interface for a user traffic transmission or a control traffic transmission is usable between base stations. A core network (CN) can consist of an AG, a network node for user registration of a user equipment and the like. The AG manages mobility of the user equipment by a unit of TA (tracking area) including a plurality of cells.

In order to improve performance of the related art LTE communication system mentioned in the above description, ongoing discussions are made on 5G communication technology. And, the 5G communication system may support cells of various types as well as an existing base station of a fixed type.

### DISCLOSURE OF THE INVENTION

### Technical Task

In the present invention, a method of efficiently supporting mobility of a user equipment and apparatus therefor are proposed.

To this end, a method and apparatus for a moving cell to efficiently transmit a synchronization signal are also proposed.

### Technical Solutions

In a first technical aspect of the present invention, provided herein is a method of performing synchronization with a base station, which is performed by a wireless device in a wireless communication system, including: receiving a primary synchronization signal and a secondary synchronization signal through a first subframe from a first base station; and performing synchronization with the first base station by using the primary synchronization signal and the secondary synchronization signal, wherein the synchronization with the first base station is performed according to whether a moving cell synchronization signal is present in the first subframe.

Preferably, the wireless device may include a moving cell or a user equipment that does not support access to the moving cell.

Additionally, when the moving cell synchronization signal is not present in the first subframe, the synchronization with the first base station may be performed.

Additionally, when the moving cell synchronization signal is present in the first subframe,

The primary synchronization signal, the secondary synchronization signal, and the moving cell synchronization signal transmitted through the first subframe may be discarded.

Additionally, a transmission period of the moving cell synchronization signal may be different from a transmission period of the primary synchronization signal and the secondary synchronization signal.

Additionally, the moving cell synchronization signal may be mapped to a slot of the first subframe, which is different from that where the primary synchronization signal and the secondary synchronization are mapped.

Additionally, when the moving cell synchronization signal is present in the first subframe, a root index of a Zadoff-Chu sequence corresponding to the primary synchronization signal may be 38.

Additionally, performing the synchronization with the first base station may include: when the moving cell synchronization signal is not present in the first subframe, determining whether the first subframe is an initial subframe through the secondary synchronization signal; and when it is determined that that the first subframe is not the initial subframe, performing the synchronization with the first base station. More preferably, performing the synchronization with the first base station may further include: when it is determined that the first subframe is the initial subframe, determining whether the moving cell synchronization signal is present in a second subframe, which is received after a predetermined number of subframes from the reception of the first subframe; and when the moving cell synchronization signal is not present in both of the first subframe and the second subframe, performing the synchronization with the first base station.

Additionally, the method may further include, when the moving cell synchronization signal is present in the first subframe, performing synchronization with a second base station that does not transmit the moving cell synchronization signal.

Additionally, the moving cell synchronization signal may have a frequency band or a length different from that of the primary synchronization signal or the secondary synchronization signal.

Additionally, when the moving cell synchronization signal is present in the first subframe, a subframe received from a serving base station connected to the wireless device may be configured as an almost blank subframe (ABS).

Additionally, the method may further include determining whether the moving cell synchronization signal is present in the first subframe.

In a second technical aspect of the present invention, provided herein is a wireless device for performing synchronization with a base station in a wireless communication system, including: a receiver configured to receive a primary synchronization signal and a secondary synchronization signal through a first subframe from a first base station; and a processor configured to perform synchronization with the first base station by using the primary synchronization signal and the secondary synchronization signal, wherein the synchronization with the first base station may be performed according to whether a moving cell synchronization signal is present in the first subframe.

### Advantageous Effects

According to the present invention, a synchronization signal for a moving cell is transmitted at a timing different from that at which a synchronization signal for a legacy user equipment is transmitted, thereby minimizing effects on cell search in the legacy user equipment and moving cell.

In addition, it is possible to prevent a delay caused when an unnecessary handover is attempted according to a movement of the moving cell in a high-dense wireless environment.

Moreover, it is possible to prevent unnecessary measurement for the moving cell in a channel quality measurement procedure.

Furthermore, by applying a cell ID sharing complex conjugate property with another cell ID in the legacy system to the moving cell, cell search in a user equipment can be performed in a simple manner

Effects obtainable from the present invention are non-limited by the above mentioned effect. And, other unmentioned effects can be clearly understood from the following description by those having ordinary skill in the technical field to which the present invention pertains.

### DESCRIPTION OF DRAWINGS

FIG. 1 is a schematic diagram of an E-UMTS network structure as an example of a wireless communication system.

FIG. 2 is a diagram illustrating an example of a 5G mobile communication system to which the present invention can be applied.

FIG. 3 is a diagram for explaining physical channels used in the LTE system and a general signal transmission method using the same.

FIG. 4 is a diagram for explaining transmission of a synchronization signal for a moving cell and a legacy synchronization signal in different frequency regions according an embodiment of the present invention.

FIG. 5 is a diagram for explaining transmission of a synchronization signal for a moving cell and a legacy synchronization signal in different frequency regions according another embodiment of the present invention.

FIG. 6 illustrates a frame structure in the LTE system.

FIG. 7 illustrates a subframe to which an MSS is mapped according to an embodiment of the present invention.

FIG. 8 illustrates a synchronization process for a user equipment according to an embodiment of the present invention.

FIG. 9 illustrates a synchronization process for a wireless device according to an embodiment of the present invention.

FIG. 10 illustrates configurations of wireless devices according to an embodiment of the present invention.

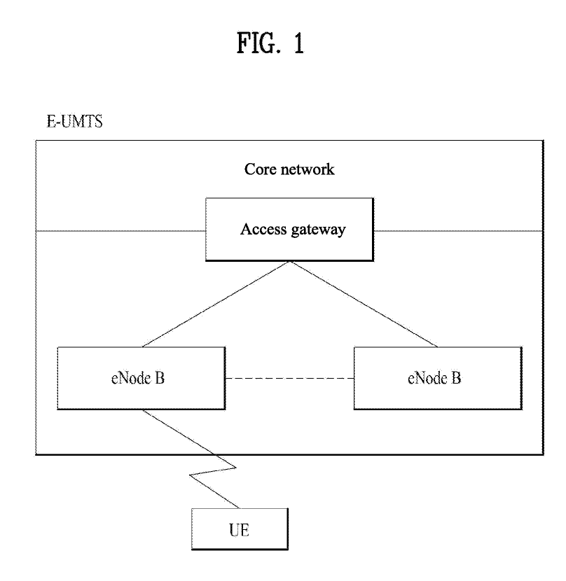

### BEST MODE FOR INVENTION

Reference will now be made in detail to the preferred embodiments of the present invention, examples of which are illustrated in the accompanying drawings. In the following detailed description of the invention includes details to facilitate the full understanding of configurations, functions and other features of the present invention. The embodiments mentioned in the following description include the examples of applying the technical features of the invention to 3GPP systems.

Although embodiments of the invention are described in the present specification using LTE system and LTE-A system for example, they are applicable to any communication systems corresponding to the above definitions.

As mentioned in the foregoing description, a 5G mobile communication system can support cells of various types as well as a cell by a fixed type base station.

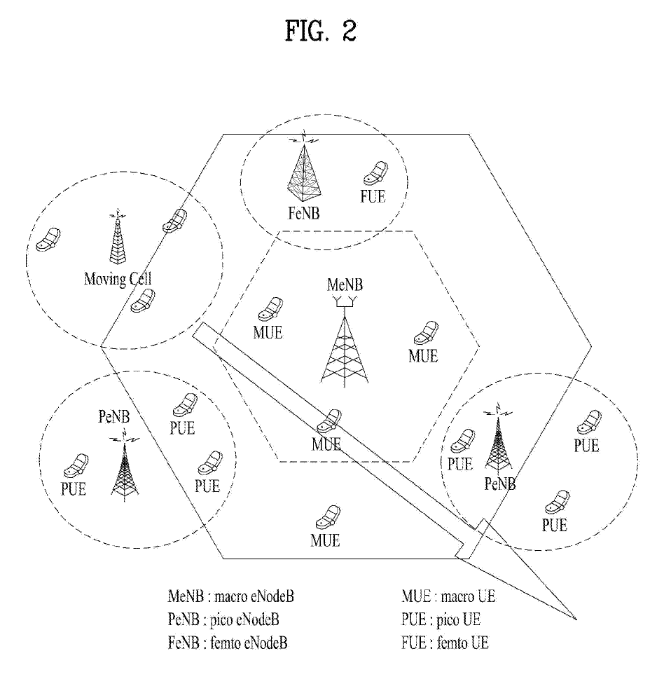

FIG. 2 is a diagram for one example of a 5G mobile communication system to which the present invention is applicable.

Referring to FIG. 2, a single macro cell may include user equipments (hereinafter called Macro UE (MUE)) serviced by a macro base station (Macro eNB (MeNB)). In addition, FIG. 2 shows that pico cells corresponding to a sort of a micro cell are formed on an edge area of a macro cell so as to be serviced by pico base station (Pico eNBs (PeNBs) and a femto base station (Femto eNB (FeNB)) configuring a femto cell. A user equipment (UE) serviced by pico base stations can be represented as Pico UE (PUE) to be distinguished from MUE. Moreover, a user equipment serviced by a femto base station can be represented as FUE to be distinguished from MUE or PUE. PeNB/FeNB is one example of a base station that provides a service to a micro cell or a small cell. And, a small base station of one of various types may correspond to the PeNB/FeNB.

Since additional installation of a macro eNB is inefficient in aspects of costs and complexity in comparison with system performance enhancement, it is estimated that utilization of a heterogeneous network by installation of the above-mentioned micro eNB (or small cell) will increase.

According to a structure of a heterogeneous network currently considered by a communication network, a multitude of micro cells coexist within a single micro cell, as shown in FIG. 2, and corresponding UEs are serviced with allocation of resource by cell coordination.

In ‘Small Cell Enhancements for E-UTRA and E-UTRAN SI’ corresponding to one field of the current standardization category of 3GPP, many ongoing discussions are made to enhance indoor/outdoor scenarios for using lower-powered nodes. In particular, the ongoing discussions are made on gains in the dual connectivity concept for a user to have dual connectivity to a macro cell layer and small cell layers using the same or different carriers. Considering such trends, as many small cells are disposed in the 5G wireless communication environment more complicatedly than shown in FIG. 2, final users seem to be located physically closer to a network.

Moreover, the present invention assumes a wireless environment in which a moving cell exists as another type of a cell. Unlike a small cell of a fixed type considered by 3GPP until now, as one example of a small cell operating method considerable in a 5G wireless communication environment, a moving cell concept can be taken into consideration. A moving cell mentioned in the following description can be illustrated into a cell that provides more capacity to final users by moving through a small base station loaded on a bus, a train, or a smart vehicle. In particular, a moving cell can be defined as a wireless node on a network forming a physical cell.

Using such a moving cell, group mobility can be provided to final users and a concentrated traffic of high capacity can be provided in backhaul link. To this end, a backhaul ranging from a fixed infrastructure to a bus/train/smart vehicle assume wireless and an in-band communication within the bus/train/smart vehicle assumes Full Duplex.

Basic features for potential application scenarios of a 5G moving cell handled by the present invention can be summarized into Table 1 as follows.

TABLE 1

| | Backhaul | | Moving | Access Link |
|---|---|---|---|---|
| Category | Distance | Mobility | Pattern | User Load |
| Public | Long | Wide speed | Fixed | Medium/High |
| Tranportation | range | | | |
| Means | | | | |
| Smart Vehicle | Medium/ | Wide speed | Arbitrary | Low/Medium |
| | Short | range | | |
| Personal Cell | Various | Low speed | Arbitrary | Low/Medium |
| | | range | | |

As mentioned in the foregoing description, in the 5G wireless communication environment, it is expected that a moving cell based communication will be performed as well as a fixed small cell based communication of the related art. In order to enable the moving cell based communication, moving cell specialized technical problems or issues differentiated from the fixed small cell based technical problems or issues should be deduced and solved, which may considerably affect current RAN.

To this end, basic operations of a user equipment and a base station in LTE system are described as follows.

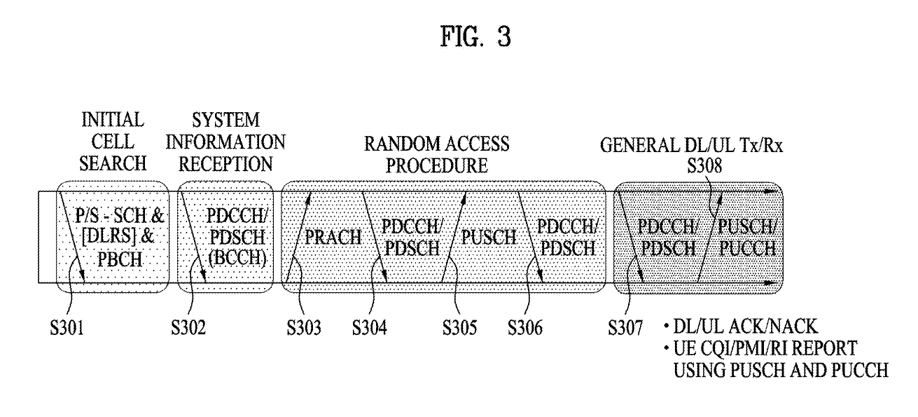

FIG. 3 is a diagram for explaining physical channels used by 3GPP system and a general signal transmitting method using the same.

Referring to FIG. 3, if a power of a user equipment is turned on or the user equipment enters a new cell, the user equipment performs an initial cell search for matching synchronization with a base station and the like [S301]. For this, the user equipment receives a primary synchronization channel (P-SCH) and a secondary synchronization channel (S-SCH) from the base station, matches synchronization with the base station and then obtains information such as a cell ID and the like. Subsequently, the user equipment receives a physical broadcast channel from the base station and is then able to obtain intra-cell broadcast information. Meanwhile, the user equipment receives a downlink reference signal (DL RS) in the initial cell searching step and is then able to check a downlink channel status.

Having completed the initial cell search, the user equipment receives a physical downlink control channel (PDCCH) and a physical downlink shared control channel (PDSCH) according to information carried on the physical downlink control channel (PDCCH) and is then able to obtain system information in further detail [S302].

Meanwhile, if the user equipment initially accesses the base station or fails to have a radio resource for signal transmission, the user equipment is able to perform a random access procedure (RACH) on the base station [S303 to S306]. For this, the user equipment transmits a specific sequence as a preamble via a physical random access channel (PRACH) [S303, S305] and is then able to receive a response message via PDCCH and a corresponding PDSCH in response to the preamble [S304, S306]. In case of contention based RACH, it is able to perform a contention resolution procedure in addition.

Having performed the above mentioned procedures, the user equipment is able to perform PDCCH/PDSCH reception [S307] and PUSCH/PUCCH (physical uplink shared channel/physical uplink control channel) transmission [S308] as a general uplink/downlink signal transmission procedure. In particular, the user equipment receives a downlink control information (DCI) via PDCCH. In this case, the DCI includes such control information as resource allocation information on a user equipment and can differ in format in accordance with the purpose of its use.

Meanwhile, control information transmitted/received in uplink/downlink to/from the base station by the user equipment includes ACK/NACK signal, CQI (channel quality indicator), PMI (precoding matrix index), RI (rank indicator) and the like. In case of the 3GPP LTE system, the user equipment is able to transmit the above mentioned control information such as CQI, PMI, RI and the like via PUSCH and/or PUCCH.

In the above-described operations of the user equipment and the base station, one problem is expected in operating the moving cell shown in FIG. 2 as follows. First of all, when a moving cell moves through the congested heterogeneous network, as shown in FIG. 2, channel quality measurements of MUEs, PUEs and FUEs are affected so that existing base stations may make unnecessary handovers into the moving cell. For instance, when a moving cell moves on a path shown in FIG. 2, an MUE having received a service through a macro cell may attempt to make a handover into the moving cell. Yet, when the corresponding MUE attempts the handover, the moving cell may have passed a location of the MUE already.

Moreover, in a moving cell supportive environment, a moving cell is configured to provide a service to UEs within the moving cell by being connected to a fixed base station like a user equipment. Hence, it is necessary for the moving cell to perform a handover procedure for a connection to a fixed cell. To this end, the moving cell (e.g., a 1^{st} moving cell) can discover a handover target by performing a channel measurement on a neighbor cell signal. Yet, in case that a different moving cell (e.g., a 2^{nd} moving cell) exists in a congested heterogeneous network environment, the 1^{st} moving cell determines a handover through a search for a 2^{nd} moving cell signal and may then attempt an unnecessary handover.

In an embodiment of the present invention for solving such a problem, it is proposed that a synchronization signal for a moving cell and a synchronization signal for a legacy user equipment are transmitted in different frequency regions in order to minimize effects of a moving cell base station on cell search of the legacy user equipment.

FIG. 4 is a diagram for explaining transmission of a synchronization signal for a moving cell and a legacy synchronization signal in different frequency regions according an embodiment of the present invention.

As shown in the leftmost side of FIG. 4, a synchronization signal in the LTE/LTE-A system is configured with a primary synchronization signal (PSS) and a secondary synchronization signal (SSS). The synchronization signal is mapped to a region with the length of 6 RBs (resource blocks) with a DC component as the center and then transmitted through a carrier frequency (fc). According to the embodiment of the present invention, to transmit the synchronization signal for the moving cell and the synchronization signal for the legacy user equipment in the different frequency regions based on the above explanation, (1) only a PSS configured for the moving cell may be transmitted in a frequency region with a length equal to or less than 6 RBs (Alt. 1 in FIG. 4), (2) only an SSS configured for the moving cell may be transmitted in the frequency region with the length equal to or less than 6 RBs (Alt. 2 in FIG. 4), or (3) both of the PSS and the SSS configured for the moving cell may be transmitted in the frequency region with the length equal to or less than 6 RBs (Alt. 3 in FIG. 4).

Although it is assumed in FIG. 4 that the synchronization signal for the moving cell is also transmitted at a location symmetrical with respect to the carrier frequency (fc), the present invention is not limited thereto.

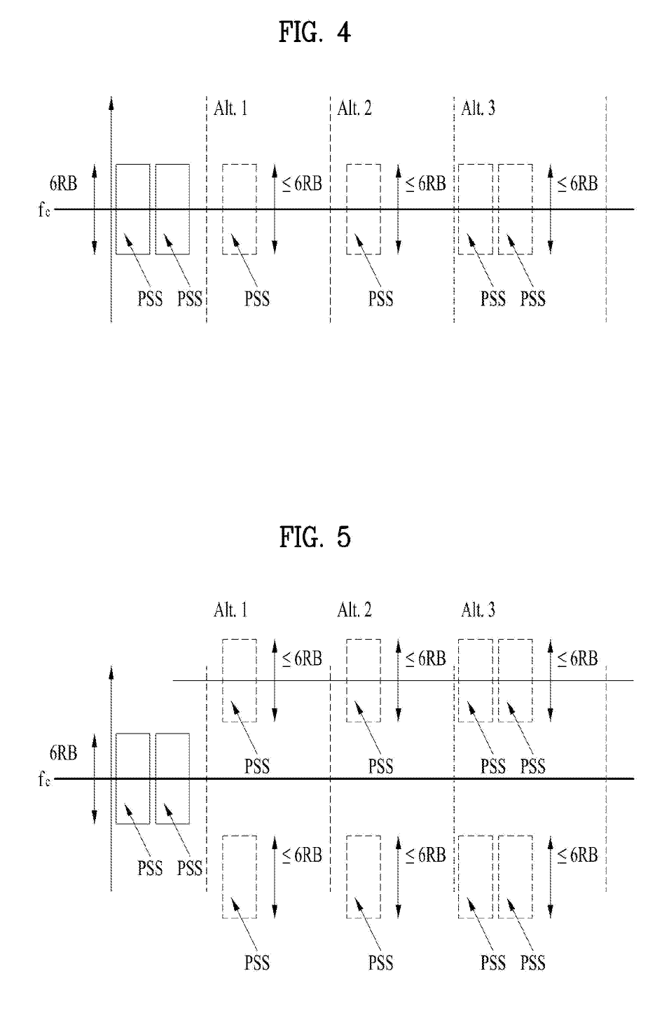

FIG. 5 is a diagram for explaining transmission of a synchronization signal for a moving cell and a legacy synchronization signal in different frequency regions according another embodiment of the present invention.

Specifically, the embodiment of FIG. 5 illustrates an example of transmitting the synchronization signal for the moving cell after mapping the synchronization signal to locations that are n apart from the carrier frequency in the positive (+) direction and/or in the negative (−) direction. Here, although a value of n is not specifically limited, it may be selected from a range of ‘− (system bandwidth/2)≦n≦(system bandwidth/2)’.

In the example of FIG. 5, each synchronization signal sequence for the moving cell may also be mapped to a frequency region with a length equal to or less than 6 RBs and then transmitted. In addition, regarding the synchronization signal for the moving cell, (1) only a PSS configured for the moving cell may be transmitted at a location ±n away from the carrier frequency in the frequency region with the length equal to or less than 6 RBs (Alt. 1 in FIG. 5), (2) only an SSS configured for the moving cell may be transmitted at the location ±n away from the carrier frequency in the frequency region with the length equal to or less than 6 RBs (Alt. 2 in FIG. 5), or (3) both of the PSS and the SSS configured for the moving cell may be transmitted at locations ±n away from the carrier frequency in the frequency region with the length equal to or less than 6 RBs (Alt. 3 in FIG. 5).

The synchronization signals for the moving cell transmitted according to FIGS. 4 and 5 may correspond to an additionally transmitted signal other than the synchronization signal of the legacy system. Although the additionally transmitted signal may be the PSS, SSS or combination thereof as shown in FIGS. 4 and 5, a new sequence defined for the moving cell may be used.

If the above-described synchronization signal sequence for the moving cell corresponds to the PSS, SSS or combination thereof, instead of or in addition to using the frequency region different from that used in the legacy system, a sequence different from that in the legacy system may be used as follows.

Thus, an embodiment of the present invention proposes to prevent the moving cell of FIG. 2 from performing a handover to a different moving cell based on information such as a cell ID for the moving cell. Similar to the LTE system, the cell ID for the moving cell may be determined as a cell ID that uses a specific root index of the Zadoff-Chu sequence (ZC sequence) in advance. In addition, a preferred embodiment of the present invention proposes to use a root index satisfying that a sum of the root index and any root index of the ZC sequence used in specifying the cell ID of the LTE system does not exceed a length of the ZC sequence as the root index of the moving cell. Details will be described in the following.

In the LTE/LTE-A, a total of 504 unique physical layer cell IDs are defined. The physical layer cell IDs are grouped into 168 unique physical layer cell ID groups and each physical cell ID group has 3 unique IDs. Thus, one physical layer cell ID is uniquely determined according to the equation of N_{ID}^{cell}=3N_{ID}⁽¹⁾+N_{ID}⁽²⁾, where N_{ID}⁽¹⁾ (physical layer cell ID group) is selected from the range of 0 to 167 and N_{ID}⁽²⁾ (physical layer ID of the physical layer cell ID group) is selected from the range of 0 to 2. In addition, N_{ID}⁽¹⁾ corresponds to the SSS (secondary synchronization signal) and N_{ID}⁽²⁾ corresponds to the PSS (primary synchronization signal).

A sequence used for the PSS, d(n) is generated from a frequency-domain ZC sequence. Here, a ZC sequence root index, u is defined as shown in Table 2 below.

TABLE 2

| N_{ID}⁽²⁾ | Root index u |
|---|---|
| 0 | 25 |
| 1 | 29 |
| 2 | 34 |

A 63-length primary synchronization signal can be generated using the above root index according Equation 1 below.

$${d}_{u} ( n ) = \{ \begin{matrix}{e}^{- j \frac{π un ( n + 1 )}{63}} & n = 0 , 1 , … , 30 \\ {e}^{- j \frac{π u ( n + 1 ) ( n + 2 )}{63}} & n = 31 , 32 , … , 61\end{matrix} \qquad [ Equation 1 ]$$

In Equation 1, a length of the generated sequence is 62 but this corresponds to the use of the 63-length ZC sequence.

Meanwhile, a sequence used for the SSS, d(0), . . . , d(61) is defined as inter-leaved concatenation of two length-31 binary sequences and the concatenated sequence is scrambled with a scrambling sequence given by the PSS. The concatenation of two length-31 sequences, which defines the SSS, may be different between subframes 0 and 5 and n is defined as 0≦n≦30.

$$d ( 2 n ) = \{ \begin{matrix}{s}_{0}^{( {m}_{0} )} ( n ) {c}_{0} ( n ) & in subframe 0 \\ {s}_{1}^{( {m}_{1} )} ( n ) {c}_{0} ( n ) & in subframe 5\end{matrix} \\ d ( 2 n + 1 ) = \{ \begin{matrix}{s}_{1}^{( {m}_{1} )} ( n ) {c}_{1} ( n ) {z}_{1}^{( {m}_{0} )} ( n ) & in subframe 0 \\ {s}_{0}^{( {m}_{0} )} ( n ) {c}_{1} ( n ) {z}_{1}^{( {m}_{1} )} ( n ) & in subframe 5\end{matrix} \qquad [ Equation 2 ]$$

In Equation 2, indices m₀ and m₁ is generated from the physical layer cell ID group and the generated indices can be defined as shown in Table 3 below.

TABLE 3

| N_{ID}⁽¹⁾ | m₀ | m₁ |
|---|---|---|
| 0 | 0 | 1 |
| 1 | 1 | 2 |
| 2 | 2 | 3 |
| 3 | 3 | 4 |
| 4 | 4 | 5 |
| 5 | 5 | 6 |
| 6 | 6 | 7 |
| 7 | 7 | 8 |
| 8 | 8 | 9 |
| 9 | 9 | 10 |
| 10 | 10 | 11 |
| 11 | 11 | 12 |
| 12 | 12 | 13 |
| 13 | 13 | 14 |
| 14 | 14 | 15 |
| 15 | 15 | 16 |
| 16 | 16 | 17 |
| 17 | 17 | 18 |
| 18 | 18 | 19 |
| 19 | 19 | 20 |
| 20 | 20 | 21 |
| 21 | 21 | 22 |
| 22 | 22 | 23 |
| 23 | 23 | 24 |
| 24 | 24 | 25 |
| 25 | 25 | 26 |
| 26 | 26 | 27 |
| 27 | 27 | 28 |
| 28 | 28 | 29 |
| 29 | 29 | 30 |
| 30 | 0 | 2 |
| 31 | 1 | 3 |
| 32 | 2 | 4 |
| 33 | 3 | 5 |
| 34 | 4 | 6 |
| 35 | 5 | 7 |
| 36 | 6 | 8 |
| 37 | 7 | 9 |
| 38 | 8 | 10 |
| 39 | 9 | 11 |
| 40 | 10 | 12 |
| 41 | 11 | 13 |
| 42 | 12 | 14 |
| 43 | 13 | 15 |
| 44 | 14 | 16 |
| 45 | 15 | 17 |
| 46 | 16 | 18 |
| 47 | 17 | 19 |
| 48 | 18 | 20 |
| 49 | 19 | 21 |
| 50 | 20 | 22 |
| 51 | 21 | 23 |
| 52 | 22 | 24 |
| 53 | 23 | 25 |
| 54 | 24 | 26 |
| 55 | 25 | 27 |
| 56 | 26 | 28 |
| 57 | 27 | 29 |
| 58 | 28 | 30 |
| 59 | 0 | 3 |
| 60 | 1 | 4 |
| 61 | 2 | 5 |
| 62 | 3 | 6 |
| 63 | 4 | 7 |
| 64 | 5 | 8 |
| 65 | 6 | 9 |
| 66 | 7 | 10 |
| 67 | 8 | 11 |
| 68 | 9 | 12 |
| 69 | 10 | 13 |
| 70 | 11 | 14 |
| 71 | 12 | 15 |
| 72 | 13 | 16 |
| 73 | 14 | 17 |
| 74 | 15 | 18 |
| 75 | 16 | 19 |
| 76 | 17 | 20 |
| 77 | 18 | 21 |
| 78 | 19 | 22 |
| 79 | 20 | 23 |
| 80 | 21 | 24 |
| 81 | 22 | 25 |
| 82 | 23 | 26 |
| 83 | 24 | 27 |
| 84 | 25 | 28 |
| 85 | 26 | 29 |
| 86 | 27 | 30 |
| 87 | 0 | 4 |
| 88 | 1 | 5 |
| 89 | 2 | 6 |
| 90 | 3 | 7 |
| 91 | 4 | 8 |
| 92 | 5 | 9 |
| 93 | 6 | 10 |
| 94 | 7 | 11 |
| 95 | 8 | 12 |
| 96 | 9 | 13 |
| 97 | 10 | 14 |
| 98 | 11 | 15 |
| 99 | 12 | 16 |
| 100 | 13 | 17 |
| 101 | 14 | 18 |
| 102 | 15 | 19 |
| 103 | 16 | 20 |
| 104 | 17 | 21 |
| 105 | 18 | 22 |
| 106 | 19 | 23 |
| 107 | 20 | 24 |
| 108 | 21 | 25 |
| 109 | 22 | 26 |
| 110 | 23 | 27 |
| 111 | 24 | 28 |
| 112 | 25 | 29 |
| 113 | 26 | 30 |
| 114 | 0 | 5 |
| 115 | 1 | 6 |
| 116 | 2 | 7 |
| 117 | 3 | 8 |
| 118 | 4 | 9 |
| 119 | 5 | 10 |
| 120 | 6 | 11 |
| 121 | 7 | 12 |
| 122 | 8 | 13 |
| 123 | 9 | 14 |
| 124 | 10 | 15 |
| 125 | 11 | 16 |
| 126 | 12 | 17 |
| 127 | 13 | 18 |
| 128 | 14 | 19 |
| 129 | 15 | 20 |
| 130 | 16 | 21 |
| 131 | 17 | 22 |
| 132 | 18 | 23 |
| 133 | 19 | 24 |
| 134 | 20 | 25 |
| 135 | 21 | 26 |
| 136 | 22 | 27 |
| 137 | 23 | 28 |
| 138 | 24 | 29 |
| 139 | 25 | 30 |
| 140 | 0 | 6 |
| 141 | 1 | 7 |
| 142 | 2 | 8 |
| 143 | 3 | 9 |
| 144 | 4 | 10 |
| 145 | 5 | 11 |
| 146 | 6 | 12 |
| 147 | 7 | 13 |
| 148 | 8 | 14 |
| 149 | 9 | 15 |
| 150 | 10 | 16 |
| 151 | 11 | 17 |
| 152 | 12 | 18 |
| 153 | 13 | 19 |
| 154 | 14 | 20 |
| 155 | 15 | 21 |
| 156 | 16 | 22 |
| 157 | 17 | 23 |
| 158 | 18 | 24 |
| 159 | 19 | 25 |
| 160 | 20 | 26 |
| 161 | 21 | 27 |
| 162 | 22 | 28 |
| 163 | 23 | 29 |
| 164 | 24 | 30 |
| 165 | 0 | 7 |
| 166 | 1 | 8 |
| 167 | 2 | 9 |
| — | — | — |
| — | — | — |

According to one aspect of the present invention, an unnecessary handover can be prevented by defining the cell ID of the moving cell as described above. Further, a method of newly configuring a PCID for the moving cell in an access link is also proposed to avoid unnecessary measurement. Specifically, according to the present embodiment, new physical layer cell IDs for moving cells are defined in addition to the existing 504 physical layer cell IDs. As a particular example, the conventional structure having the PSS from 0 to 2 and the SSS from 0 to 167 is modified to a structure having the PSS from 0 to 3 and the SSS from 0 to 167. That is, it is proposed not to change the SSS structure but to change the number of PSSs from three to four in order to configure the cell ID for the moving cell.

As described above, the PSS is generated based on the 63-length ZC sequence in the current LTE/LTE-A. Root indices 29, 34, and 25 are used for generating the ZC sequence. A sum of the root indices 29 and 34 among the root indices used for generating the ZC sequence corresponds to the length of the ZC sequence, i.e., 63.

When the sum of the root indices corresponds to the ZC sequence length as described above, two sequences are in a complex conjugate relation in terms of an equation for generating the ZC sequence such as Equation 1. Such two sequence in the complex conjugate relation have advantages of reducing the amount of operations for the cell search. That is, when performing the cell search, a user equipment can reuse a median value of one correlation operation for another correlation operation instead of performing correlation operations on the individual sequences.

Accordingly, the present invention proposes that when 168 cell IDs are newly defined by adding one root index as described in the present embodiment, the added root index is configured such that a sum of the added root index and the root index of the legacy system corresponds to the ZC sequence length.

As mentioned in the foregoing description, the root indices 29, 34, and 25 of the ZC sequence are used for the PSS generation in the LTE system. Among the above root indices, the root indices 29 and 34 satisfy the condition that a sum thereof is 63. Thus, the present embodiment proposes to use the root index 38 in defining the new cell IDs. The root index 38 is advantageous in that since a sum of the root index 38 and the root index 25 of the legacy system corresponds to the ZC sequence length of 63, the root indices 38 and 25 can create a root index pair having the complex conjugate property.

Another embodiment of the present invention proposes to utilize a total of six root indices for the newly defined cell IDs by adding three root indices instead of adding a single root index. In this case, the total six root indices are configured such that every two root indices make the root index pair in the complex conjugate relation as described above. Moreover, in this case, a sum of a root index of the ZC sequence for a moving cell ID and a specific root index of the legacy system may correspond to the ZC sequence length. Alternatively, a sum of the root index of the ZC sequence for the moving cell ID and the newly defined root index may correspond to the ZC sequence length.

In the current LTE/LTE-A, the number of the physical layer cell IDs is defined as 504, which is obtained by combining PSS code sequences and SSS code sequences. In addition, the cell search means a procedure by which a user equipment obtains time/frequency synchronization with respect to a specific cell and identifies a cell ID of the specific cell as described above. That is, the E-UTRA cell search is performed based on the PSS/SSS transmitted in DL. The PSS/SSS based cell search is also applied to a neighboring cell search for measurement during a handover.

However, in the case of the moving cell, which will be applied to the 5G wireless communication environment, once a UE boards a bus, train or smart vehicle, the UE recognizes the corresponding bus, train or smart vehicle as its own serving cell. Then, the UE may transceive DL/UL control signals or DL/UL data through the bus, train, or smart vehicle. The above-mentioned communication environment is different from the fixed small cell based communication, which has been considered until the conventional 4G wireless communication environment. In the case of the bus, train or smart vehicle, since a plurality of UEs need to be served, reliability or delay in the communication service may become a more important issue. In other words, to achieve the communication through the moving cell, the moving cell should provide high quality of services to users by accurately reflecting environmental changes in accordance with its movement.

Moreover, in the case of the neighboring cell search for channel measurement during the handover, which is defined in the 4G based wireless communication environment, if the moving cell performs the measurement by detecting other moving cells in an access link other than fixed base stations in a backhaul link, it may cause unnecessary measurement overhead to the moving cell. Furthermore, the above problem may cause the same problem to other cells located adjacent to a moving path of the moving cell as well.

As described above, if the new cell ID for the moving cell is determined in advance, a moving cell base station can prevent the moving cell from performing a handover to a different moving cell and an unnecessary measurement.

Hereinafter, 6 RBs (or less than 6 RBs) of the additional PSS, SSS, PSS/SSS, or the new sequence, which are mentioned in the above embodiments, is referred to as an MSS (moving cell synchronization signal) for convenience of description.

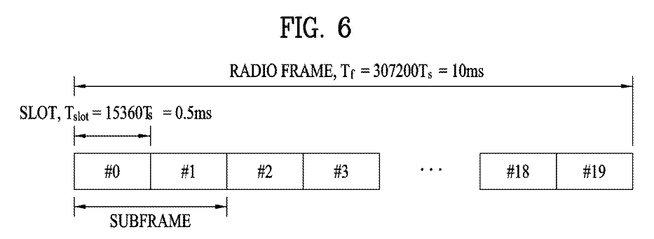

FIG. 6 illustrates a frame structure in the LTE system. As shown in FIG. 6, a single subframe is composed of two slots and each slot includes seven symbols in case of normal CP (cyclic prefix) and six symbols in case of extended CP (cyclic prefix).

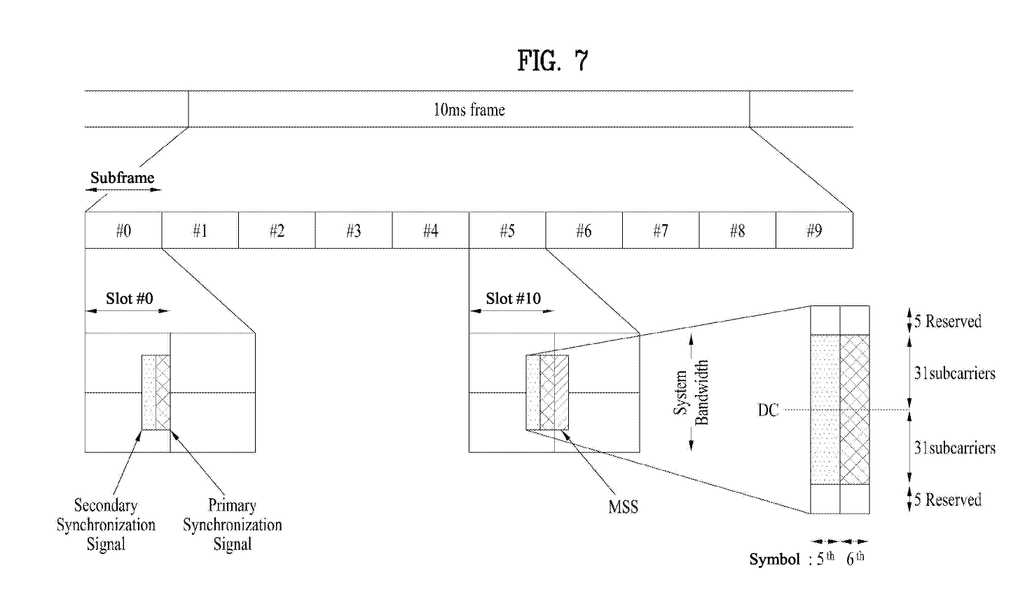

FIG. 7 illustrates a subframe in which an MSS is transmitted according to an embodiment of the present invention.

The MSS needs to be transmitted in the same time region in both cases of the normal CP and extended CP. According to an embodiment of the present invention, the MSS is mapped to a first OFDM symbol of a second slot of a subframe not to increase detection hypotheses. That is, the SSS, PSS and MSS are consecutively mapped in the time domain. As a result, a user equipment may detect the MSS immediately after detecting the SSS and PSS. As described above, early detection of the MSS is configured to maintain proximity to the legacy PSS and SSS.

Hence, similar to the PSS and SSS, a method of mapping the MSS to every subframes #0 and #5 can be considered. However, since a first OFDM symbol of a second slot of the subframe #0 corresponds to a region for transmitting a PBCH, the MSS is mapped to a first symbol of a second slot of the subframe #5 except the subframe #0 not to affect PBCH reception, which is performed by the legacy user equipments in the subframe #0. In addition, since transmission of the maximum 6 RBs is performed on the minimum bandwidth (1.44 MHz), the MSS may be mapped to 6 RBs with reference to the center frequency. The CRS, which has been mapped to the first symbol of the second slot of the subframe #5, is punctured for the MSS transmission. Although FIG. 7 illustrates that the MSS is located at the same frequency as the PSS and SSS, it is merely an example and the present invention is not limited thereto.

Meanwhile, in the case of the SSS, one SSS is selected from the 168 SSSs similar to the related art. In the case of the PSS, a new PSS is generated using the newly defined root index (e.g., root index 38). In the case of the MSS, which needs to be detected by a backhaul DL receiver of a neighboring moving cell, it may have the same form as the SSS obtained by interleaving two M-sequences for the purpose of not causing a problem to detection performance of a UE. However, the MSS is not limited thereto. Thus, the total number of PCIDs that can be managed by a moving cell may be 168*168 (i.e., 168 SSSs*1 PSS*168 MSSs). Both a 5G user equipment and a moving cell can detect SSS+PSS+MSS but the legacy user equipment cannot detect it.

Hereinafter, operations of user equipments in the moving cell will be described. The MSS may cause interference to the legacy user equipments connected to a macro base station when the legacy user equipments receives data from the macro base station. For instance, in the moving cell, the legacy user equipment may recognize the MSS as data. When the legacy user equipment boards the moving cell, the macro base station may configure a subframe of the macro base station, which is simultaneously transmitted with a subframe of the moving cell through which the MSS is transmitted, as an ABS (almost blank subframe). Since the macro base station dose not perform scheduling by configuring the subframe as the ABS, the MSS may not affect data reception and data decoding at the legacy user equipment.

Since the 5G user equipment is able to receive data from both of the macro base station and the moving cell, the macro base station may perform puncturing or rate-matching on the corresponding location of the subframe transmitted by the macro base station by considering time and frequency locations to which the MSS is mapped. That is, by transmitting data after emptying time and frequency regions identical to those for the MSS or transmitting data after the regions in which the MSS is transmitted, the macro base station may not affect data reception and data decoding at the 5G user equipment.

To prevent the moving cell from unnecessarily accessing a neighboring moving cell, the moving cell detects the additional SSS/PSS/MSS-based cell ID as well as the conventional cell ID configured based on the SSS and PSS. On the other hand, similar to the related art, the legacy user equipment detects only the cell ID configured based on the SSS/PSS. When the corresponding technique is applied, 5G UEs may detect the cell ID configured based on the MSS having equal to or less than 6 RBs, which is additionally transmitted together with the previously configured SSS/PSS. In other words, since the new cell ID is added based on the SSS/PSS/MSS without any effects on the legacy user equipments, the 5G user equipments can recognize the moving cell. Moreover, a measurement configuration is configured such that the macro base station does not measure a neighboring moving cell when the moving cell performs a handover. Hence, it is possible not only to reduce measurement overhead of the moving cell but also to prevent an unnecessary handover in advance.

Meanwhile, in the case of a user equipment that does not support the moving cell, priority of downlink synchronization may be configured. When a user equipment respectively detects a legacy synchronization signal (e.g., 3 PSS/168 SSS) and a moving cell synchronization signal (e.g., 1 PSS/168 SSS+MSS) from the fixed base station and the moving cell, the priority may be configured such that the user equipment preferentially matches downlink synchronization with reference to the legacy synchronization signal. As a result, the user equipment performs synchronization with the fixed base station rather than the moving cell.

In the case of a user equipment that supports the moving cell, the user equipment detects the moving cell synchronization signal (e.g., 1 PSS/168 SSS+MSS) and then obtains a cell ID of the moving cell through the detection. Thereafter, the user accesses the moving cell using the cell ID of the moving cell. The user equipment supporting the moving cell can simultaneously match synchronization with the fixed base station and the moving cell.

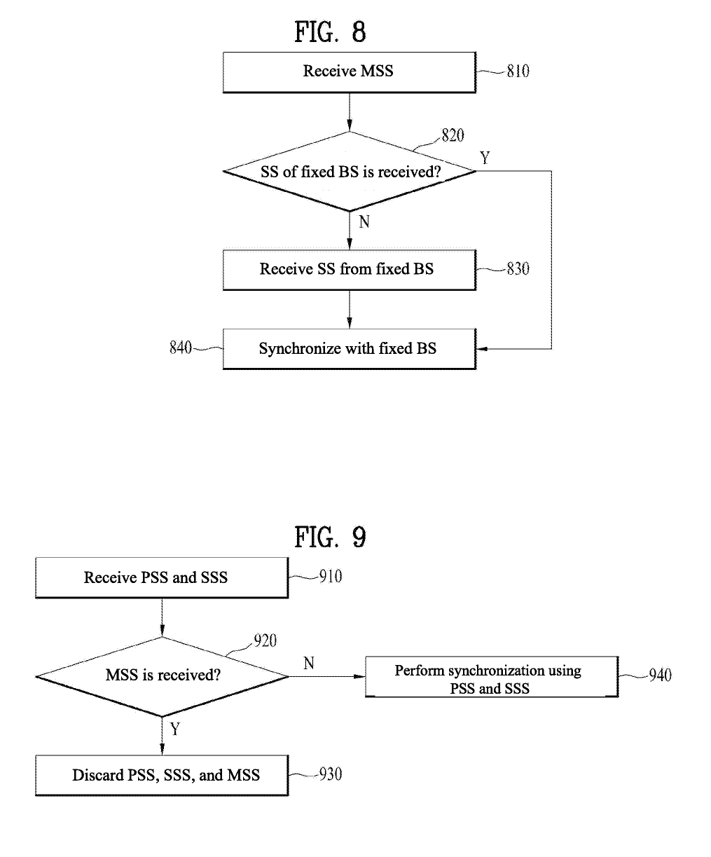

FIG. 8 illustrates a synchronization process for a user equipment according to an embodiment of the present invention. In FIG. 8, the user equipment may be a user equipment that does not support access to a moving cell.

The user equipment receives an MSS [810]. Subsequently, the user equipment determines whether a synchronization signal of a fixed base station is received [820]. When the user equipment receives the synchronization signal of the fixed base station, the user equipment performs downlink synchronization with the fixed base station using a PSS and an SSS of the fixed base station [840]. When the user equipment fails to receive the synchronization signal of the fixed base station, the user equipment stands by until receiving the synchronization signal of the fixed base station [830]. Thereafter, the user equipment performs the downlink synchronization using the received synchronization signal of the fixed base station [840].

On the other hand, when the user equipment receives the synchronization signal of the fixed base station before receiving an MSS, the user equipment performs synchronization with the fixed base station without waiting for reception of the MSS.

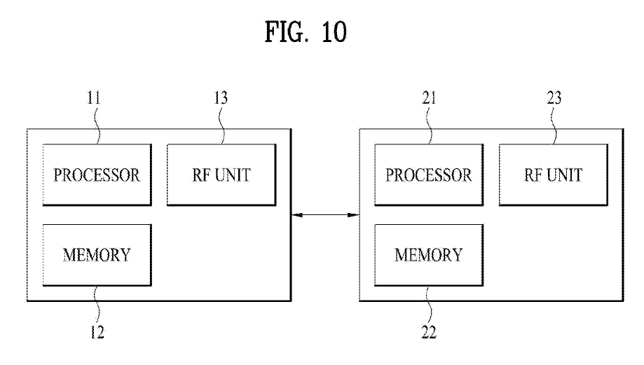

FIG. 9 illustrates a synchronization process for a wireless device according to an embodiment of the present invention. In FIG. 9, the wireless device may correspond to a moving cell or a user equipment that does not support access to the moving cell. However, the present invention is not limited thereto.

To access only fixed base stations except an access link of the moving cell, the wireless device is configured to receive and detect a synchronization signal of a fixed base station and ignore a PSS and an SSS transmitted with an MSS of the moving cell. That is, any combination of SSS/PSS/MSS is not included in access targets of the wireless device.

Referring to FIG. 9, the wireless device receives the PSS and the SSS through a first frame from a first base station [910].

Thereafter, the wireless device determines whether the MSS exists in the first subframe [920]. The PSS and SSS are transmitted in subframes #0 and #5, whereas the MSS is transmitted only in subframe #5. Thus, a transmission period of the MSS is twice longer than that of the PSS and SSS. In addition, the PSS and SSS are mapped to a first slot, whereas the MSS is mapped to a second slot. When the MSS is present in the first subframe, a root index of the Zadoff-Chu sequence corresponding to the PSS may be 38. A frequency band or a length of the MSS is different from that of the PSS and SSS.

When the MSS is present in the first subframe, the wireless device discards the PSS, SSS, and MSS transmitted through the first subframe [930]. Subsequently, the wireless device receives a PSS and an SSS from a second base station that does not transmit an MSS and then performs synchronization with the second base station.

When the MSS is not present in the first subframe, the wireless device performs synchronization using the PSS and SSS [940].

Hereinafter, a synchronization procedure will be described in detail. The wireless device needs to determine whether the first subframe is the subframe #0 or the subframe #5. This is because if the first subframe is the subframe #0, the MSS may be transmitted in the subframe #5. Hence, the wireless device determines whether the first subframe is the subframe #0 by using the SSS. The reason for this is that sequence interleaving applied to the SSS mapped to the subframe #0 is different from that applied to the SSS mapped to the subframe #5.

When determining that the first subframe is not the subframe #0, i.e., the first subframe is the subframe #5, the wireless device performs the synchronization with the first base station.

When determining that the first subframe is the subframe #0, the wireless device waits for reception of the subframe #5 and then determines whether the MSS is present in the subframe #5. If the MSS is not present even in the subframe #5, the wireless device performs the synchronization with the first base station. When detecting the MSS from the subframe #5, the wireless device does not perform the synchronization with the first base station.

As mentioned in the foregoing description, the synchronization with the base station is performed according to whether the MSS is present in the first subframe. In other words, the synchronization with the first base station is performed when the MSS is not present in the first subframe.

FIG. 10 illustrates configurations of wireless devices according to an embodiment of the present invention.

Referring to FIG. 10, a wireless device may be configured to include a processor 11, a memory 12, and an RF module 13. The wireless device may perform communication with another wireless device including the same components 21, 22, and 23. The RF module 13 may include a transmitter and a receiver.

In FIG. 10, a wireless device may correspond to a UE and another wireless device may correspond to a moving cell or a fixed base station. The wireless devices in FIG. 10 are illustrated for convenience of description. If necessary, some of the modules may be omitted. In addition, the wireless devices may further include necessary modules.

The processors 11 and 21 of the wireless devices may perform most of controls for implementing the above-described methods according to the embodiments of the present invention. The memories 12 and 22 are respectively connected to the processors 11 and 21 so as to store necessary information. The RF units 13 and 23 may transmit and receive radio signals and then forward the radio signals to the processors 11 and 21, respectively.

According to an embodiment of the present invention, the RF module 13 receives a primary synchronization signal and a secondary synchronization signal through a first subframe from a first base station. The processor 11 performs synchronization with the first base station using the primary synchronization signal and the secondary synchronization signal. The synchronization with the first base station is performed according to whether a synchronization signal of a moving cell is present in the first subframe.

The aforementioned embodiments are achieved by combination of structural elements and features of the present invention in a predetermined type. Each of the structural elements or features should be considered selectively unless specified separately. Each of the structural elements or features may be carried out without being combined with other structural elements or features. Also, some structural elements and/or features may be combined with one another to implement the embodiments of the present invention. The order of operations described in the embodiments of the present invention may be changed. Some structural elements or features of one embodiment may be included in another embodiment, or may be replaced with corresponding structural elements or features of another embodiment.

The embodiments of the present invention can be implemented using various means. For instance, the embodiments of the present invention can be implemented using hardware, firmware, software and/or any combinations thereof. In the implementation by hardware, each embodiment of the present invention can be implemented by at least one of ASICs (application specific integrated circuits), DSPs (digital signal processors), DSPDs (digital signal processing devices), PLDs (programmable logic devices), FPGAs (field programmable gate arrays), processors, controllers, microcontrollers, microprocessors, and the like.

In case of the implementation by firmware or software, each embodiment of the present invention can be implemented by modules, procedures, and/or functions for performing the above-explained functions or operations. Software code may be stored in the memory unit and then be driven by the processor. The memory unit is provided within or outside the processor to exchange data with the processor through the various means known in public.

It will be apparent to those skilled in the art that the present invention may be embodied in other specific forms without departing from the spirit and essential characteristics of the invention. Thus, the above embodiments should be considered in all respects as exemplary and not restrictive. The scope of the present invention should be determined by reasonable interpretation of the appended claims and the present invention covers the modifications and variations of this invention that come within the scope of the appended claims and their equivalents.

### INDUSTRIAL APPLICABILITY

The above-described present invention can be applied to various wireless communication systems.

What is claimed is:

1. A method of performing synchronization with a base station, which is performed by a wireless device in a wireless communication system, the method comprising:
receiving a primary synchronization signal and a secondary synchronization signal through a first subframe from a first base station; and
performing synchronization with the first base station by using the primary synchronization signal and the secondary synchronization signal,
wherein the synchronization with the first base station is performed according to whether a moving cell synchronization signal is present in the first subframe.

2. The method of claim 1, wherein the wireless device comprises a moving cell or a user equipment that does not support access to the moving cell.

3. The method of claim 1, wherein when the moving cell synchronization signal is not present in the first subframe, the synchronization with the first base station is performed.

4. The method of claim 1, wherein when the moving cell synchronization signal is present in the first subframe, the primary synchronization signal, the secondary synchronization signal, and the moving cell synchronization signal transmitted through the first subframe are discarded.

5. The method of claim 1, wherein a transmission period of the moving cell synchronization signal is different from a transmission period of the primary synchronization signal and the secondary synchronization signal.

6. The method of claim 1, wherein the moving cell synchronization signal is mapped to a slot of the first subframe, which is different from a slot where the primary synchronization signal and the secondary synchronization are mapped.

7. The method of claim 1, wherein when the moving cell synchronization signal is present in the first subframe, a root index of a Zadoff-Chu sequence corresponding to the primary synchronization signal is 38.

8. The method of claim 1, wherein performing the synchronization with the first base station comprises:
when the moving cell synchronization signal is not present in the first subframe, determining whether the first subframe is an initial subframe through the secondary synchronization signal; and
when it is determined that the first subframe is not the initial subframe, performing the synchronization with the first base station.

9. The method of claim 8, wherein performing the synchronization with the first base station further comprises:
when it is determined that the first subframe is the initial subframe, determining whether the moving cell synchronization signal is present in a second subframe, which is received after a predetermined number of subframes from the reception of the first subframe; and
when the moving cell synchronization signal is not present in both of the first subframe and the second subframe, performing the synchronization with the first base station.

10. The method of claim 1, further comprising:
when the moving cell synchronization signal is present in the first subframe, performing synchronization with a second base station that does not transmit the moving cell synchronization signal.

11. The method of claim 1, wherein a frequency band or a length of the moving cell synchronization signal is different from a frequency band or a length of the primary synchronization signal or the secondary synchronization signal.

12. The method of claim 1, wherein when the moving cell synchronization signal is present in the first subframe, a subframe received from a serving base station connected to the wireless device is configured as an almost blank subframe (ABS).

13. The method of claim 1, further comprising:
determining whether the moving cell synchronization signal is present in the first subframe.

14. A wireless device for performing synchronization with a base station in a wireless communication system, comprising:
a receiver configured to receive a primary synchronization signal and a secondary synchronization signal through a first subframe from a first base station; and
a processor configured to perform synchronization with the first base station by using the primary synchronization signal and the secondary synchronization signal,
wherein the synchronization with the first base station is performed according to whether a moving cell synchronization signal is present in the first subframe.
